(19) United States
(12) Patent Application Publication
(10) Pub. No.: US 2024/0241339 A1
(43) Pub. Date: Jul. 18, 2024

(54) LENS MOUNT DEVICE AND LENS ASSEMBLY

(71) Applicant: KYOCERA SOC Corporation, Yokohama (JP)

(72) Inventor: Takao TANABE, Kanagawa (JP)

(21) Appl. No.: 18/319,816

(22) Filed: May 18, 2023

(30) Foreign Application Priority Data
Jan. 12, 2023 (JP) 2023-003391

(51) Int. Cl. G02B 7/02

(52) U.S. Cl. CPC G02B 7/021; G02B 7/028

(57) ABSTRACT

A lens mount device includes a lens and a lens mount member for holding the lens. The lens mount member has an annular part surrounding the lens. The annular part includes a first annular part having a first inner peripheral surface such that a first space having a first radial dimension is defined between the first inner peripheral surface and an outer peripheral surface of the lens and a second annular part having a second inner peripheral surface such that a second space having a second radial dimension smaller than the first radial dimension is defined between the second inner peripheral surface and the outer peripheral surface of the lens, the first and second annular parts being adjacent to each other in an axial direction of the lens. An elastomer member is placed in the first space without radial gaps. The second space is an air gap.

### TECHNICAL FIELD

The present invention relates to a lens mount device and a lens assembly, and more specifically relates to a mechanically athermalized lens mount device and a lens assembly provided with the same.

### BACKGROUND ART

Objective lens devices (lens assemblies) used in semiconductor inspection devices are required to have high resolution to improve defect detection sensitivity. The minimum resolution of the objective lens devices is inversely proportional to the numerical aperture (NA) and is proportional to the observation wavelength. Therefore, to achieve a practically usable resolution, a numerical aperture greater than or equal to 0.75 is generally required in an ultraviolet region where the wavelength is less than 400 nm.

Such objective lens devices have very high error sensitivity. Therefore, to demonstrate optimal performance, multiple lens elements (hereinafter referred to as lenses) configuring an objective lens device must be arranged with substantially no decentration. Also, changes of the refractive index, thickness, and radius of curvature of the lenses due to temperature change and aberration change caused by change of intervals between the lenses due to expansion of the barrel must be minimized.

The temperature range in which these objective lens devices are used (use temperature range) should be maintained to 21° C. to 25° C., for example. In addition, even if the objective lens devices are exposed to a greater temperature range (for example, −10° C. to +60° C.) than the use temperature range during storage, transportation, or the like, the performance of the objective lenses is required to return to the original when the temperature returns to the use temperature range.

An objective lens device includes lenses and annular lens mount members that surround and hold the lenses. Conventionally, the lenses of an objective lens device used in a deep ultraviolet region are constituted of quartz lenses or a combination of quartz lenses and fluorite lenses (Non-Patent Document 1). Also, the lens mount members are made of stainless steel, brass, or the like.

In such an objective lens device, since the linear expansion coefficient of quartz in the lens material is very small, the difference between the linear expansion coefficient of the lens and the linear expansion coefficient of the lens mount member is large and thermal stress occurs between the lens mount member and the lens due to temperature change. This thermal stress may cause misalignment of the lenses of the objective lens device to cause decentration of the lenses so that comatic aberration may occur. Also, there is a risk that the refractive index change and expansion/contraction of the lens caused by temperature change may lead to imbalanced lens power so that spherical aberration may change. These aberrations due to temperature change are collectively referred to as thermal aberration. Here, particularly, the former is called decentering thermal aberration and the latter is called coaxial thermal aberration.

If temperature change occurs inside a semiconductor inspection device having such an objective lens device built therein, there is a risk that due to decentering or coaxial thermal aberration of the objective lens device, the imaging performance may be lowered so that the defect detection sensitivity of the semiconductor inspection device may be lowered. Also, if the objective lens device is exposed to large temperature change of several tens degrees during transportation/storage of the semiconductor inspection device, the lens performance may not return to the original when the temperature returns to the use temperature.

To solve the above-described problems regarding thermal aberration, devices with the following configurations have been proposed.

As a device with a first configuration, there is known a device in which the lens mount is given a characteristic (flexure) of an elastic body so that mismatch of the linear expansion coefficient between the lens and the lens mount is absorbed by elastic deformation of the lens mount (for example, Patent Documents 1 and 2). According to this configuration, almost all thermal aberrations when temperature changes are converted to deformation of the elasticity body or rotational motion of the lens, and decentering movement of the lens is suppressed.

As a device with a second configuration, there is known a device in which an elastomer layer (typically, RTV rubber) interposed between the lens and the lens mount is made thicker than usual (for example, Non-Patent Document 2 and Patent Document 3). The linear expansion coefficient of the elastomer layer is about 10 times those of common metal materials, and due to this effect, an expansion difference between the lens made of quartz and the lens mount member made of metal is absorbed when the temperature rises.

As a device with a third configuration, there is known a device in which multiple materials having different linear expansion coefficients are used to balance the linear expansion coefficient of the lens mount and the linear expansion coefficient of the lens and to absorb thermal stress (for example, Patent Documents 4, 5, 6, and 7).

As a device with a fourth configuration, there is known a device in which a lens material and a barrel material having approximate linear expansion coefficients are selected (for example, Patent Documents 8 and 9).

As a device with a fifth configuration, there is known a device in which thermal environment of or around the lens is detected and the internal pressure, temperature, and/or position of the lens is controlled accordingly to control thermal effects (for example, Patent Document 10). In such a configuration, an asymmetrical temperature raising device may be mounted on the lens to correct non-uniform temperature increase due to illumination light. Also, there is known a device configured to be capable of moving at least two independent lenses relative to the other fixed lenses to keep the performance of the projection lens constant under various disturbances (for example, Patent Document 11).

### PRIOR ART DOCUMENT(S)

### Patent Document(s)

[Patent Document 1] US4,929,054A
[Patent Document 2] U.S. Pat. No. 9,400,367B2
[Patent Document 3] US4,850,674A
[Patent Document 4] US6,040,950A
[Patent Document 5] U.S. Pat. No. 6,229,657B1
[Patent Document 6] JP2020-38251A
[Patent Document 7] JP2022-71687A
[Patent Document 8] JPS58-90605A
[Patent Document 9] JPS58-171009A
[Patent Document 10] U.S. Pat. No. 6,521,877B1
[Patent Document 11] DE10146499A1
[Patent Document 12] U.S. Pat. No. 7,636,209B2

### Non-Patent Document(s)

[Non-Patent Document 1] J. Webb et al, Optical Design Forms for DUV&VUV Microlithographic Processes, Optical Microlithography XIV, Christopher J. Progler, Editor, Proceedings of SPIE Vol. 4346 (2001)
[Non-Patent Document 2] M. Bayer, Lens barrel optomechanical design principles, Opt, Eng, 1981, Vol. 20, No. 2

The devices with the above-described configurations for alleviating the problems of thermal aberration have following problems.

In the device with the first configuration, since a structure for making the lens mount member have sufficient elasticity is included, it is difficult to keep the outer diameter of the lens mount member to the size similar to that of a device not adopting such a structure. Also, complex machining is necessary to realize the elastic structure of the lens mount member, and this machining can cause cost increase. Further, there is a problem that it is difficult to achieve both high precision machining and complex machining of the lens mount member. Further, there is a risk that if a large disturbance or the like acts on the lens mount device or a large temperature change occurs, the lens mount member may deform considerably and the lens may accordingly be displaced considerably so that the original optical performance may be lost. Also, if the elastic structure is caused to deform beyond the elastic limit by disturbances or the like, the lens may not return to the original position, and thus, impact stability is not sufficient.

In the device with the second configuration, since the elastomer layer is thick, the lens may be contaminated by produced out gas so that the transmittance may be lowered in the deep ultraviolet region. Also, it is difficult to precisely control the thickness of the elastomer layer, and therefore, generation of additional stress due to non-uniformity of the elastomer layer is concerned. Further, there is a risk that if a large disturbance or the like acts on the lens mount device or a large temperature change occurs, the elastomer layer may deform considerably and the lens may accordingly be displaced considerably so that the original optical performance may be lost. Also, if the elastic structure is caused to deform beyond the elastic limit by disturbances or the like, the lens may not return to the original position, and thus, impact stability is not sufficient.

In the device with the third configuration, since the lens mount member is configured by multiple concentric members, there is a problem that the dimension of the lens device in the radial direction becomes large. Also, in this configuration, the difference in thermal expansion/contraction due to temperature change between the barrels is not taken into account, and therefore, there is a problem that temperature change may cause excessive stress acting on the barrels so that distortion of the barrels may occur, or, conversely, stress may be reduced too much so that the lenses cannot be fixed in the barrels problem.

In the device with the fourth configuration, thermal stress is suppressed because the linear expansion coefficients of the material of the lens and the material of the barrel are approximate to each other, but a concrete range of degree of approximation of them is not clear. Also, there is no consideration of an elastomer layer, which is a common fixing means when fixing high precision lens. This indicates that influence of the linear expansion coefficient difference that slightly remains between the material of the lens and the material of the barrel cannot be removed, and it cannot be applied as it is to a high precision lens. Also, thermal aberration such as spherical aberration change due to temperature change is not taken into account, and thus the spherical aberration due to temperature change may become large. Therefore, the barrel structure disclosed in the prior art documents cannot be used as it is in a high precision objective lens.

In the device with the fifth configuration, means for detecting the temperature or aberration of the lens and means for changing a state of a part of the lens are necessary. Namely, an optical system incorporated with this configuration would become a very large system and would not be suitable for an objective lens assembly for an inspection device which needs to have a complete function with a single objective lens.

### SUMMARY OF THE INVENTION

The present invention has been made in view of the aforementioned problems and a primary object of the present invention is to provide a lens mount device which can reduce thermal stress applied to the lens and has excellent impact stability in which the lens is prevented from being displaced much even if a large disturbance or the like is applied to the lens mount device. Another object of the present invention is to provide a lens mount assembly including a plurality of such lens mount devices.

To achieve the above object, one aspect of the present invention provides a lens mount device (10), comprising: a lens (12); and a lens mount member (14) for holding the lens, wherein the lens mount member has an annular part (16) surrounding the lens, the annular part comprises a first annular part (16A) having a first inner peripheral surface (16D) such that a first space (20) having a first radial dimension is defined between the first inner peripheral surface and an outer peripheral surface (12A) of the lens and a second annular part (16B) having a second inner peripheral surface (16E) such that a second space (22) having a second radial dimension smaller than the first radial dimension is defined between the second inner peripheral surface and the outer peripheral surface of the lens, the first annular part and the second annular part being adjacent to each other in an axial direction of the lens, an elastomer member (30) is placed in the first space without radial gaps, and the second space is an air gap.

According to this aspect, the lens mount can reduce thermal stress applied to the lens is reduced and moreover has excellent impact stability in which the lens is prevented from being displaced much even if a large disturbance or the like is applied to the lens mount device.

Preferably, the lens mount member comprises a third annular part (16C) provided adjacent to the second annular part to define a shoulder portion (16G) contacting an incident surface or an exit surface of the lens.

According to this aspect, displacement of the lens in the optical axis direction relative to the lens mount member is prevented.

Preferably, the elastomer member extends continuously over an entire circumference of the first space.

According to this aspect, the lens is evenly supported by the lens mount member via the elastomer member over the entire circumference, and the thermal stress is relieved favorably by the elastomer member.

Preferably, the elastomer member is provided in at least three positions of the first space at intervals in a circumferential direction.

According to this aspect, it is possible to reduce influence of out gas released from the elastomer by reducing the absolute amount of the elastomer while holding the lens with mechanically sufficient strength.

Preferably, a material of the elastomer member is silicone rubber.

According to this aspect, the thermal stress is relieved favorably by the elastomer member. This is because silicone rubber has a sufficiently small Young's modulus compared to metal and glass.

Preferably, the elastomer member has a radial width greater than or equal to 2% of an outer diameter of the lens.

According to this aspect, the thermal stress is relieved favorably by the elastomer member. This is because the thermal stress due to expansion/contraction depends on a strain ε of the elastomer, where ε=(deformation amount)/(radial width), and thus the strain can be made relatively small by sufficiently increasing the denominator in the above formula.

Preferably, a material of the lens is CaF₂, and a material of the lens mount member is austenitic stainless steel or brass.

According to this aspect, when the material of the lens is CaF₂, the linear expansion difference between the lens and the lens mount member can be made small.

Preferably, a material of the lens is synthetic quartz, and a material of the lens mount member is invar steel or super invar steel.

According to this aspect, when the material of the lens is synthetic quartz, the linear expansion difference between the lens and the lens mount member can be made small.

Preferably, a material of the lens is optical glass, and a material of the lens mount member is martensitic stainless steel, ferritic stainless steel, or titanium alloy.

According to this aspect, when the material of the lens is optical glass, the linear expansion difference between the lens and the lens mount member can be made small.

To achieve the above object, another aspect of the present invention provides a lens assembly (40), comprising: multiple lens mount devices (10) each consisting of the lens mount device according to the above aspect; and a barrel (42) accommodating the multiple lens mount devices along an optical axis direction, wherein materials of the lens mount members of the multiple lens mount devices are same as each other, and a material of the barrel and the material of the lens mount members are same as each other.

According to this aspect, even under large temperature change, application of thermal stress to a specific lens mount device or reduction of axial force can be avoided. To achieve the above object, another aspect of the present invention provides a lens assembly (50, 60), comprising multiple lens mount devices (10) arranged along an optical axis direction, each of the multiple lens mount devices consisting of the lens mount device according to the above aspect, wherein materials of the lens mount members of the multiple lens mount devices are same as each other, and the lens mount members of the lens mount devices that are adjacent to each other in the optical axis direction are coupled to each other by fasteners (52, 54, 62, 64).

According to this aspect, even under large temperature change, application of thermal stress to a specific lens mount device or reduction of axial force can be avoided.

Preferably, materials of the lenses of the multiple lens mount devices are same as each other.

According to this aspect, the lens mount members corresponding to the respective lenses can be made of materials having the same linear thermal expansion coefficient which is the same as or approximate to the linear thermal expansion coefficient of the lenses.

According to the above aspect, a lens mount device which can reduce thermal stress applied to the lens and has excellent impact stability in which the lens is prevented from being displaced much even if a large disturbance or the like is applied to the lens mount device is provided. Also, a lens mount assembly including a plurality of such lens mount devices is provided.

### BRIEF DESCRIPTION OF THE DRAWINGS

FIG. 1 is a sectional view showing one embodiment of a lens mount device according to the present invention;

FIG. 2 is a partial enlarged sectional view of a main part of the lens mount device according to the embodiment;

FIG. 3 is a partial enlarged sectional view of the lens mount device according to the embodiment before an elastomer member is fitted;

FIG. 4 is a front view of the lens mount device according to the embodiment;

FIG. 5 is a front view of a lens mount device according to another embodiment;

FIG. 6 is a sectional view showing one embodiment of a lens assembly in which the lens mount device according to the embodiment is used;

FIG. 7 is a sectional view showing another embodiment of a lens assembly in which the lens mount device according to the embodiment is used; and

FIG. 8 is a sectional view showing yet another embodiment of a lens assembly in which the lens mount device according to the embodiment is used.

### DETAILED DESCRIPTION OF THE INVENTION

In the following, embodiments of the present invention will be described in detail with reference to the drawings.

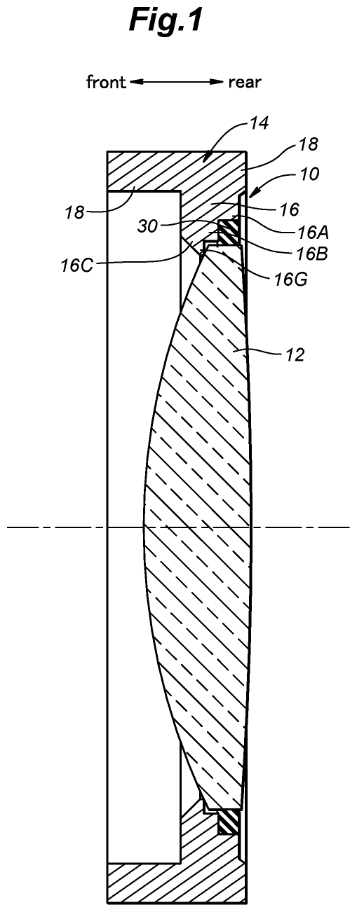

As shown in FIGS. 1 to 4, a lens mount device 10 according to one embodiment of the present invention includes a lens 12 and a lens mount member 14 for holding the lens 12.

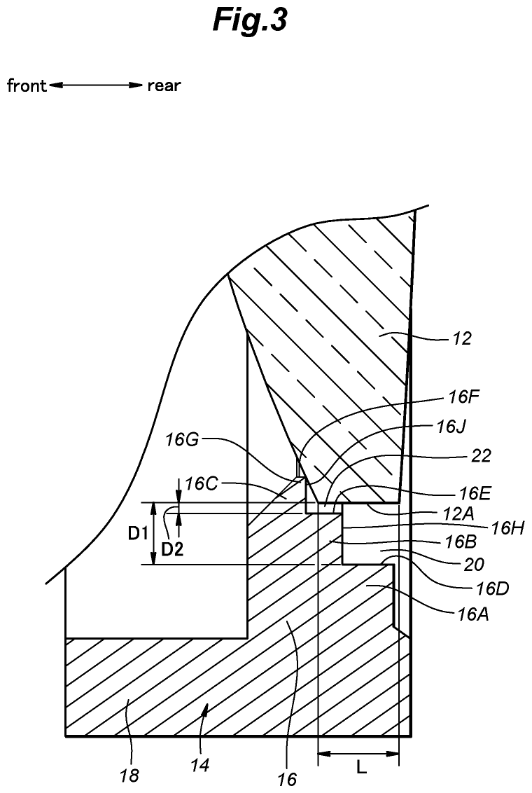

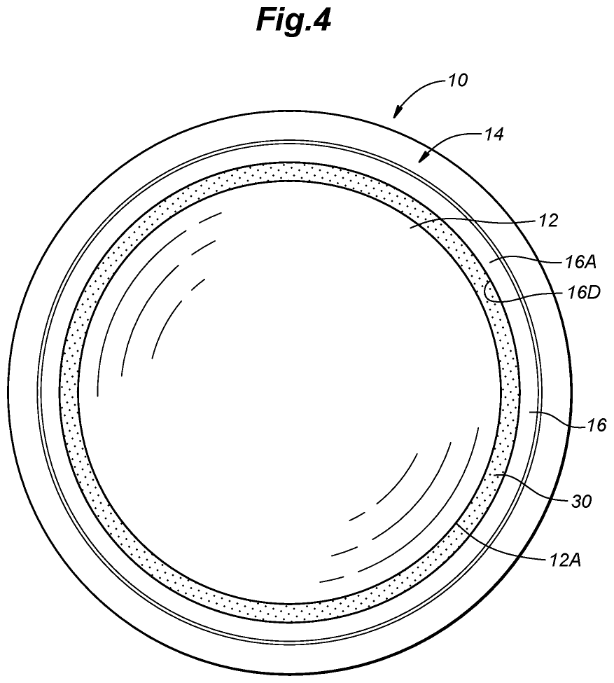

The lens 12 has an outer peripheral surface (circumferential surface) 12A which is circular as seen in front view (see FIG. 4) and has a dimension L in the axial direction (see FIG. 3). The lens 12 is made of CaF₂ (calcium fluoride), which is also called fluorite, quartz, optical glass such as S-BSL7, or the like.

The lens mount member 14 integrally includes a circular annular part 16 which surrounds the lens 12 and two axial position restricting parts 18 which are cylindrical in shape and extend from the radially outer end of the circular annular part 16 in opposite directions along the axial direction. The axial position restricting parts 18 set a spacing between the lenses 12 in the optical axis direction in a later-described lens assembly (lens group) 40.

The lens mount member 14 is preferably made of a material having a linear thermal expansion coefficient same as or close to the linear thermal expansion coefficient of the lens 12. Therefore, when the material of the lens 12 is CaF₂, the material of the lens mount member 14 preferably is austenitic stainless steel or brass. When the material of the lens 12 is synthetic quartz, the material of the lens mount member 14 preferably is invar steel or super invar steel. When the material of the lens 12 is optical glass, the material of the lens mount member 14 preferably is martensitic stainless steel, ferritic stainless steel, or titanium alloy.

The circular annular part 16 includes a first circular annular part 16A, a second circular annular part 16B, and a third circular annular part 16C arranged in order in an axial direction of the lens 12 (optical axis direction=front-rear direction) to be adjacent and concentric to each other.

As shown in FIG. 3, the first circular annular part 16A has a first inner peripheral surface 16D having an inner diameter larger than the outer diameter of the outer peripheral surface 12A of the lens 12. In the initial state, the first inner peripheral surface 16D opposes the outer peripheral surface 12A of the lens 12 in a concentric state such that a first space 20 having a circular annular shape with a first radial dimension D1 between the first inner peripheral surface 16D and the outer peripheral surface 12A of the lens 12.

As shown in FIG. 3, the second circular annular part 16B has a second inner peripheral surface 16E having an inner diameter larger than the outer diameter of the outer peripheral surface 12A of the lens 12 and smaller than the inner diameter of the first inner peripheral surface 16D. In the initial state, the second inner peripheral surface 16E opposes the outer peripheral surface 12A of the lens 12 in a concentric state such that a second space 22 having a circular annular shape with a second radial dimension D2 smaller than the first radial dimension D1 is defined between the second inner peripheral surface 16E and the outer peripheral surface 12A of the lens 12.

Between the first inner peripheral surface 16D and the second inner peripheral surface 16E, a first end surface 16H extending in a direction perpendicular to the axial direction of the lens 12 (namely, extending in the radial direction of the lens 12) is provided. In other words, the first inner peripheral surface 16D and the second inner peripheral surface 16E are directly connected by the first end surface 16H which extends in the direction perpendicular to the axial direction of the lens 12.

As shown in FIG. 3, the third circular annular part 16C has a third inner peripheral surface 16F having an inner diameter smaller than the inner diameter of the first inner peripheral surface 16D and the inner diameter of the second inner peripheral surface 16E and includes a shoulder portion (inward extension part) 16G extending more in the radial direction than the second circular annular part 16B. The shoulder portion 16G has a rear tip corner contacting a part of the incident surface (front surface) of the lens 12 in the vicinity of the outer edge to perform positioning of the lens 12 in the axial direction relative to the lens mount member 14. In other words, the lens 12 is prevented from being displaced forward relative to the lens mount member 14 by the tip corner of the shoulder portion 16G contacting a part of the front surface of the lens 12 in the vicinity of the outer edge.

Between the second inner peripheral surface 16E and the third inner peripheral surface 16F, a second end surface 16J extending in the direction perpendicular to the axial direction of the lens 12 (namely, extending in the radial direction of the lens 12) is provided. In other words, the second inner peripheral surface 16E and the third inner peripheral surface 16F are directly connected by the second end surface 16J which extends in the direction perpendicular to the axial direction of the lens 12. The aforementioned tip corner of the shoulder portion 16G that contact the lens 12 is defined by the second end surface 16J and the third inner peripheral surface 16F to have a substantially right angle.

In the first space 20, an elastomer member (elastomer layer) 30 is disposed. The elastomer member 30 is made of RTV rubber. RTV rubber is an abbreviation of Room Temperature Vulcanizing rubber. Strictly speaking, RTV rubber refers to liquid rubber that cures at room temperature, but liquid rubbers used as adhesives, seals, etc. for electric/electronic use or general industrial use may be collectively referred to as RTV rubber. RTV rubber typically is silicone rubber and is characterized by a large linear expansion coefficient and a small Young's modulus compared to metal and glass. Here, the elastomer member 30 is made of silicone rubber.

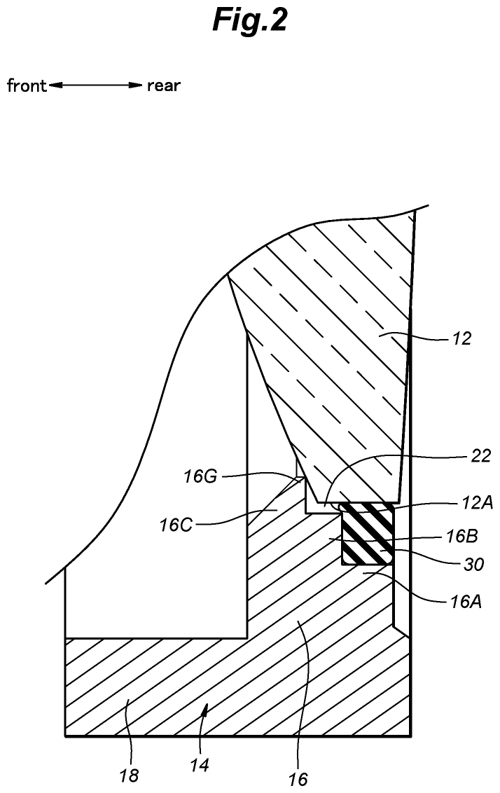

The elastomer member 30 is formed by pouring liquid rubber into the first space 20 from above in a posture in which the third circular annular part 16C is positioned on a lower side (a posture rotated counterclockwise by 90 degrees from the posture shown in FIGS. 2 and 3) and causing the liquid rubber to cure in the first space 20, and fills the entirety of the first space 20 without gaps in a state adhered to each of the outer peripheral surface 12A of the lens 12, the first inner peripheral surface 16D and the first end surface 16H of the first circular annular part 16A. Thereby, the elastomer member 30 extends continuously over the entire circumference of the first space 20 and has a circular annular shape that is substantially the same as that of the first space 20.

When the lens 12 and the lens mount member 14 are displaced relative to each other in the radial direction, the elastomer member 30 elastically deforms in the compression and tensile direction, and when the lens 12 and the lens mount member 14 are displaced relative to each other in the axial direction, the elastomer member 30 elastically deforms in a shear direction. Note that the relative displacement of the lens 12 and the lens mount member 14 in the axial direction is limited to rearward displacement of the lens 12 relative to the lens mount member 14 because the tip corner of the shoulder portion 16G contacts the front surface of the lens 12, and therefore, the elastic deformation of the elastomer member 30 in the shear direction is limited to that caused by the displacement in this direction.

In the lens mount device 10, if the linear expansion coefficient of the lens 12 and the linear expansion coefficient of the lens mount member 14 are substantially the same, a difference in thermal expansion due to temperature change between the lens 12 and the lens mount member 14 is small. Even if a thermal expansion difference remains between the lens 12 and the lens mount member 14, the above-described elastic deformation of the elastomer member 30 provided between the lens 12 and the lens mount member 14 alleviates the stress produced by the thermal expansion difference between the lens 12 and the lens mount member 14. Thus, in the lens mount device 10, generation of decentering thermal aberration and coaxial thermal aberration in the lens 12 due to temperature change is suppressed.

To undergo elastic deformation thereby to favorably alleviate the stress generated due to the thermal expansion difference between the lens 12 and the lens mount member 14, the elastomer member 30 preferably has a radial width that is a predetermined ratio of the outer diameter of the lens 12. One element that determines this ratio is an elastic property of the material constituting the elastomer member 30. When the elastomer member 30 is made of silicone rubber, it is preferred that the elastomer member 30 has a radial width that is 2% or greater of the outer diameter of the lens 12. The radial width of the elastomer member 30 is equal to the first radial dimension D1 of the first space 20 and is defined as an appropriate value by the first radial dimension D1. Thereby, the stress generated due to the thermal expansion difference between the lens 12 and the lens mount member 14 is favorably alleviated by the elastic deformation of the elastomer member 30.

Provided that the lens 12 is made of CaF₂, the lens mount member 14 is made of austenitic stainless steel, and the outer diameter of the lens 12 is 25.5 mm, the thickness (radial width) of the elastomer member 30 may be 0.6 mm. In this case, the elastomer member 30 has a thickness that is about 2.3% of the lens outer diameter. Of course, the elastomer member 30 may be set to have a greater thickness, but reducing the thickness of the elastomer member 30 to below 2% of the lens outer diameter is not preferable because it may result in excessive stress applied to the lens 12.

The elastomer member 30 is not disposed in the second space 22, and the second space 22 is an air gap. Therefore, the relative displacement between the lens mount member 14 and the lens 12 in the radial direction is limited to a displacement equal to the second radial dimension D2 of the second space 22, which is determined by contact of the second inner peripheral surface 16E of the lens mount member 14 with the outer peripheral surface 12A of the lens 12.

Thereby, even if a large disturbance acts on the lens mount device 10, the lens 12 is prevented from being displaced relative to the lens mount member 14 in the radial direction beyond the second radial dimension D2, and the original optical performance of the lens mount device 10 can be maintained.

Also, the maximum deformation of the elastomer member 30 in the radial direction is restricted by the second space 22 and the elastomer member 30 is prevented from deforming in the radial direction beyond the elastic limit or deforming considerably such that residual deformation occurs. Therefore, a problem that the lens 12 does not return to the original position after deformation of the elastomer member 30 can be avoided.

Owing to the above features, the impact stability of the lens mount device 10 is improved with compact configuration.

Further, by defining the second space 22 to be minimum in a range in which the lens 12 and the second circular annular part 16B do not interfere with each other within the use temperature range, in other words, by defining the second space 22 such that the lens 12 and the second circular annular part 16B do not make interference fit even if temperature change occurs, it is possible to suppress displacement of the lens 12 relative to the lens mount member in the radial direction. Therefore, the amount of deformation of the elastomer member 30 can be reliably suppressed to within the elastic deformation range, permanent deformation of the elastomer member 30 can be avoided and optical error can be minimized.

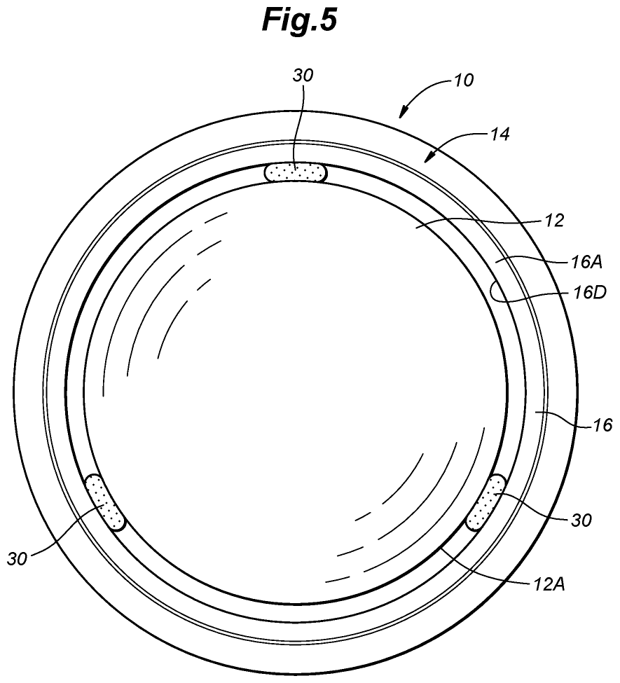

Note that the elastomer member 30 does not necessarily have to extend continuously over the entire circumference of the first space 20 and, as shown in FIG. 5, may be provided in pieces disposed in three positions of the first space 20 at equal intervals (at 120 degree intervals) in the circumferential direction. In this case also, operation and effect similar to those when the elastomer member 30 extends continuously over the entire circumference of the first space 20 can be obtained.

With the elastomer member 30 provided intermittently in the circumferential direction of the first space 20, it is possible to hold the lens with mechanically sufficient strength, and further, compared to the case where the elastomer member 30 is provided over the entirety of the circumferential direction of the first space 20, the amount of elastomer material constituting the elastomer member 30 can be reduced and the amount of out gas released from the elastomer can be reduced. Therefore, contamination of the lens 12 due to the out gas can be reduced, and as a long-term effect, lowering of the transmittance of the lens 12 is suppressed.

The elastomer member 30 may be intermittently provided at more than three positions, such as four positions or five positions, in the circumferential direction of the first space 20.

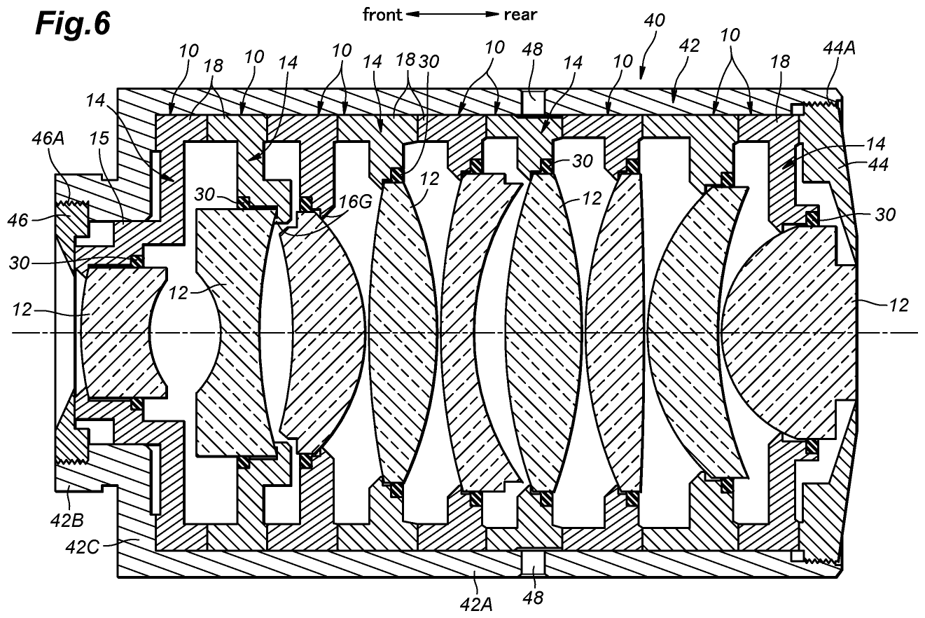

FIG. 6 shows one embodiment of a lens assembly 40 which may be used as an objective lens device or the like of a semiconductor inspection device, a microscope functioning with an ultraviolet laser light source, or the like.

The lens assembly 40 includes multiple lens mount devices 10 described above and a barrel 42 accommodating the multiple lens mount devices 10 arranged in the optical axis direction.

The lens mount members 14 included in the lens assembly 40 may be made of materials having the same linear expansion coefficient or mutually approximate linear expansion coefficients. Also, the lenses 12 of the lens assembly 40 may be made of materials having the same linear expansion coefficient or mutually approximate linear expansion coefficients. The all lenses 12 of the lens assembly 40 may be made of CaF₂ or quartz, and in this case, the linear expansion coefficients of the lenses 12 are the same as each other.

When the materials of the lenses 12 of the multiple lens mount devices 10 are the same as each other, the lens mount members 14 corresponding to the respective lenses 12 can be made of materials having the same linear thermal expansion coefficient which is the same as or approximate to the linear thermal expansion coefficient of the lenses 12.

The lens unit configured by the lenses 12, namely, the lens assembly 40 operates at a wavelength of 266 nm, has a field of view p of 0.4 mm, and has a numerical aperture NA of 0.85, for example.

The barrel 42 is made of the same material as the material of the lens mount member 14 of each lens mount device 10 or a material having a linear expansion coefficient which is the same as or approximate to the linear expansion coefficient of the lens mount member 14. The barrel 42 is formed in a cylindrical shape having open ends and includes a large-diameter cylindrical part 42A, a small-diameter cylindrical part 42B provided on a front side of the large-diameter cylindrical part 42A, and a front end portion 42C that has a disc shape and connects the large-diameter cylindrical part 42A and the small-diameter cylindrical part 42B.

With the outer peripheral surface of the lens mount member 14 of each lens mount device 10 fitted on the inner peripheral surface of the large-diameter cylindrical part 42A, the lens mount devices 10 are accommodated in the barrel 42 such that they are arranged in the optical axis direction to have a prescribed common axis. In the following description, the multiple lens mount devices 10 accommodated in the barrel 42 may be referred to as a lens mount group.

At the rear opening of the large-diameter cylindrical part 42A, a pressing ring 44 having a circular annular shape is threadedly engaged with the large-diameter cylindrical part 42A via a threaded part 44A formed on the outer circumference of the pressing ring 44. By turning the pressing ring 44 to move forward relative to the large-diameter cylindrical part 42A, the pressing ring 44 pushes the front axial position restricting part 18 of the front-most lens mount device 10 in the lens mount group against the front end portion 42C, and make the front axial position restricting part 18 and the rear axial position restricting part 18 of the lens mount members 14 that are adjacent in the optical axis direction contact each other thereby to fix the lens mount group relative to the barrel 42 with the intervals between the adjacent lenses 12 in the optical axis direction being set.

An intermediate portion of the barrel 42 in the optical axis direction is formed with adjustment holes 48 at multiple positions in the circumferential direction such that the adjustment holes 48 penetrate therethrough. The adjustment holes 48 are access holes for performing decentration adjustment of the lens mount device 10 located at the axial position corresponding to the adjustment holes 48. Due to the decentration adjustment of the lens mount device 10 through the adjustment holes 48, decentration adjustment of the whole lens mount group is performed so as to optimize the comatic aberration. Note that the lens mount member 14 of the lens mount device 10 that is the target of the decentration adjustment has an outer diameter part slightly smaller than the other.

The lens mount member 14 of the front-most lens mount device 10 has a small-diameter cylindrical part 15 that fits into the small-diameter cylindrical part 42B. A disc-shaped member 46 is attached to the small-diameter cylindrical part 42B. Preferably, the disc-shaped member 46 is threadedly engaged with the small-diameter cylindrical part 42B via a threaded part 46A formed on the outer circumference of the disc-shaped member 46. The disc-shaped member 46 is not in contact with the lens mount member 14 and has a tapered opening to function as an optical aperture (lens hood) that cuts off excess light.

The metal materials of the barrel 42 and the lens mount members 14 of the lens mount devices 10 that configure the lens assembly 40 are all the same, or the linear thermal expansion coefficients of the barrel 42 and each lens mount member 14 are the same or approximate to each other, whereby a large thermal stress does not occur between the barrel 42 and each lens mount member 14. Therefore, even under large temperature change, application of thermal stress to a specific lens mount device 10 or reduction of axial force can be avoided.

Also, since the lenses 12 of the multiple lens mount devices 10 are made of the same material or materials having the same linear thermal expansion coefficient, the lens mount members 14 for the respective lenses 12 can be made of the same material having a linear thermal expansion coefficient whose difference from the linear thermal expansion coefficient of the lenses 12 is zero or small.

Note that materials different from the materials of the barrel 42 and the lens mount members 14 may be used in ancillary parts of the lens assembly 40, such as setscrews and the like.

In the above-described lens assembly 40, with a barrel structure that is easy to be machined, compact, and simple, the thermal stress applied to the lenses 12 can be reduced so that slight decentration of the lens 12 is prevented, and the refractive index change accompanying temperature change and the decentering aberration change caused by dimensional change can be reduced.

In the following, basis of the aforementioned operation and effect of the lens mount device 10 and the lens assembly 40 will be described.

Table 1 shows materials that may be used to configure the lens mount device 10 and the lens assembly 40, together with a physical property value (linear expansion coefficient (CTE)) and a Young's modulus of each material, which will be used in the following description.

TABLE 1

| | | linear expansion | Young's |
|---|---|---|---|
| | | coefficient | modulus |
| classification | material | CTE[×10⁻⁶] | [GPa] |
| austenitic stainless steel | SUS304 | 17.3 | 193 |
| | SUS316 | 16 | 193 |
| free cutting brass | C3604 | 20.5 | 98 |
| aluminum alloy | A5056 | 24.3 | 70.6 |
| martensitic stainless steel | SUS410 | 10.4 | 200 |
| ferritic stainless steel | SUS430 | 10.4 | 200 |
| super invar | IC-36FS | 0.7 | 136 |
| titanium alloy | Ti—6Al—4V | 8.8 | 110 |
| elastomer | *) | 210 | 0.004 |
| lens material | CaF₂ | 18.4 | 91 |
| | quartz | 0.6 | 72 |
| lens material (optical | S-BSL7 | 7.2 | 80 |
| glass) | S-TIM2 | 8.1 | 78 |
| | S-FPL53 | 14.5 | 69 |
| | S-LAM60 | 5.4 | 113 |

*) K. B. Doyle, Athermal design of nearly incompressible bonds, Proceedings of SPIE Vol. 4771 (2002)

Austenitic stainless steel, free cutting brass, aluminum alloy, martensitic stainless steel, ferritic stainless steel, super invar, and titanium alloy in Table 1 are metal materials that may configure the lens mount member 14. The elastomer configuring the elastomer member 30 is equivalent to RTV rubber in the document.

Here, D represents a diameter of the lens 12, and t represents a radial clearance between the lens 12 and the lens mount member 14 (the thickness of the elastomer member 30). In the embodiment shown in FIGS. 2 and 3, t=D1.

First, it will be described that as a result of selection of appropriate materials of the lens 12 and the lens mount member 14 and appropriate thickness of the elastomer member 30, lens decentration due to temperature change can be absorbed.

Provided that the linear expansion coefficient of the lens 12 is α_{G}, the linear expansion coefficient of the lens mount member 14 is α_{M}, and the linear expansion coefficient of the elastomer member 30 is α_{E}, a change of the clearance between the lens 12 and the lens mount member 14 is represented as shown in Equation (1).

$$Δ = \frac{D}{2} ( {α}_{M} - {a}_{G} ) + t ( {α}_{M} - {α}_{E} ) \qquad ( 1 )$$

The strain of the elastomer member 30 is represented by the following Equation (2).

$$ε = \frac{Δ}{t} = \frac{D}{2 t} ( {α}_{M} - {α}_{G} ) + ( {α}_{M} - {α}_{E} ) \qquad ( 2 )$$

As a concrete example, substituting α_{G}=18.4×10⁻⁶ (CaF₂), α_{M}=17.3×10⁻⁶ (SUS304), α_{E}=210×10⁻⁶ (RTV rubber) into the above equation gives the following Equation (3).

$$ε = - 1.1 \times {10}^{- 6} \times \frac{D}{2 t} - 192.7 \times 1 {0}^{- 6} \qquad ( 3 )$$

The first term represents the strain due to the linear expansion coefficient difference between the lens 12 and the lens mount member 14, and the second term represents the strain produced by the elastomer member 30 itself.

Here, if the thickness t of the elastomer member 30 is below 2% of the lens diameter, the first term exceeds one-tenth of the second term in magnitude, and the influence thereof cannot be ignored. Conversely, if the thickness t of the elastomer member 30 is sufficiently large, the first term can be ignored because the first term is inversely proportional to t. Since the Young's modulus of the elastomer member 30 is about 1/50000 of that of metal and is about 1/20000 of that of glass, the stress transmitted from the elastomer member 30 to the lens mount member 14 and the lens 12 at this time can be ignored. Therefore, the linear expansion difference slightly remaining between the lens mount member 14 and the lens 12 can be absorbed by making the elastomer member 30 thick, and even if temperature change occurs, almost no decentering force acts on the lens 12.

Next, it will be described that appropriate selection of materials of the mount and the lens can suppress occurrence of aberration in the optical axis direction.

The power φ of a thin single lens having a front surface with a radius of curvature R1, a rear surface with a radius of curvature R2, and a refractive index n is given by the following Equation (4).

$$φ = \frac{1}{f} = ( n - 1 ) ( \frac{1}{{R}_{1}} - \frac{1}{{R}_{2}} ) \qquad ( 4 )$$

where f is a focal length of the lens.

Differentiating this with temperature T gives the following Equation (5).

$$\frac{d φ}{dT} = - \frac{1}{{f}^{2}} \frac{df}{dT} = \frac{dn}{dT} ( \frac{1}{{R}_{1}} - \frac{1}{{R}_{2}} ) - ( n - 1 ) ( \frac{1}{{R}_{1}^{2}} \frac{{dR}_{1}}{dT} - \frac{1}{{R}_{2}^{2}} \frac{{dR}_{2}}{dT} ) \qquad ( 5 )$$

Here, a change of the radius of curvature R with temperature is represented by the following Equation (6).

$$R + Δ R = ( 1 + {α}_{G} Δ T ) R \qquad ( 6 )$$

Namely, following Equation (7) holds.

$$\frac{dR}{dT} = {α}_{G} R \qquad ( 7 )$$

Hence, following Equations (8) and (9) hold.

$$\begin{matrix}\frac{d φ}{dT} = - \frac{1}{{f}^{2}} \frac{df}{dT} \\ = \frac{dn}{dT} ( \frac{1}{{R}_{1}} - \frac{1}{{R}_{2}} ) - {α}_{G} ( n - 1 ) ( \frac{1}{{R}_{1}} - \frac{1}{{R}_{2}} ) \\ = ( \frac{dn / dT}{n - 1} - {α}_{G} ) φ\end{matrix} \qquad ( 8 )$$

$$\frac{df}{dT} = - ( \frac{dn / dT}{n - 1} - {α}_{G} ) f \qquad ( 9 )$$

As a concrete example, a case where CaF₂ is used as the lens material and SUS304 is used as the barrel material is described. For example, in the case of i-line (365 nm), the refractive index n is 1.44488 and the temperature coefficient of the refractive index is represented by the following Equation (10).

$$\frac{dn}{dT} = - 10.6 \times {10}^{- 6} \qquad ( 10 )$$

The linear expansion coefficient of the lens 12 is represented by the following Equation (11).

$${α}_{G} = 18.4 \times 1 {0}^{- 6} \qquad ( 11 )$$

Thus, the linear expansion coefficient is represented by the following Equation (12).

$$\frac{df}{dT} = - ( \frac{\frac{dn}{dT}}{n - 1} - {α}_{G} ) f = 42.22 \times {10}^{- 6} f \qquad ( 12 )$$

Namely, it is shown that the focal length changes (becomes longer) by 42.22×10⁻⁶ f per 1° C. On the other hand, the back focus change due to the barrel material is expressed as α_{f}=17.3×10⁻⁶ f in the case of SUS304 (namely, the back focus becomes longer with temperature). Therefore, the focal length change due to characteristic change of the lens material and the focal position change due to linear expansion of the barrel 42 cancel out each other to a certain extent, and the focus fluctuation and the spherical aberration change related thereto can be reduced. Substantially same effect can be also expected in the case of SUS316 which has a similar linear expansion coefficient (16×10−6).

On the other hand, in a case where the lens 12 uses, of the typical materials that may be used in the ultraviolet region, quartz (this is not an optimal condition), since the linear expansion coefficient of quartz (and hence, α_{G}) is 0.6×10⁻⁶, super invar which has a linear expansion coefficient of 0.7×10⁻⁶ is suitable as the barrel material to suppress the decentering thermal aberration. However, since super invar is easy to rust and has magnetism, it is not suitable for use in general devices. Therefore, as a second best, use of SUS304 may be considered.

In this case, the coaxial thermal aberration will be as follows. In the case of i-line (365 nm), the refractive index n is 1.47464 and the temperature coefficient of the refractive index is represented as dn/dT=10.3×10⁻⁶, and therefore, the following Equation (13) is obtained.

$$\frac{df}{dT} = - ( \frac{\frac{dn}{dT}}{n - 1} - {α}_{G} ) f = - 21.1 \times {10}^{- 6} f \qquad ( 13 )$$

Namely, with a quartz lens, the focal length becomes shorter as the temperature rises. On the other hand, when the barrel 42 is made of SUS304, the barrel 42 expands at a rate of 17.3×10⁻⁶, and therefore, the difference between them tends to be amplified. Therefore, it is understood that compared to the lens 12 made of CaF₂, the lens 12 made of quartz is disadvantageous from the viewpoint of thermal aberration.

Patent Documents 4, 5, 6, and 7 disclose methods for avoiding the above problems by combining materials having various linear expansion coefficients, but use of barrel materials having different linear expansion coefficients may result in excessive or too little axial force under temperature change. In the case of the former, deformation of the lens due to strain may be caused, and in the case of the latter, lens decentration due to insufficient holding force may be caused, which, as a result, may lead to deterioration of the lens performance.

Thus, it is concluded that the lens assembly 40 characterized by that the all lens materials consist of CaF₂, the all barrel materials consist of austenitic stainless steel, each lens mount member 14 defines an air gap between itself and the corresponding lens 12, each lens 12 is fixed to the corresponding lens mount member 14 by the elastomer member 30, and the thickness t of the elastomer member 30 in the radial direction is greater than or equal to 2% of the lens diameter is optimal for ensuring the lens performance under large temperature change.

It is desirable that the linear expansion coefficient α_{G} of the lens 12 and the linear expansion coefficient α_{M} of the barrel material satisfy Inequality (14).

$$\vert {α}_{G} - {α}_{M} \vert ≦ 6 \times {10}^{- 6} \qquad ( 14 )$$

Specifically, when the lens material is CaF₂, the barrel material preferably is SUS304 (|α_{G}−α_{M}|=1.1×10⁻⁶), SUS316 (|α_{G}−α_{M}|=2.4×10⁻⁶), C3604 (|α_{G}−α_{M}|=2.1×10⁻⁶) or the like. Also, when the lens material is synthetic quartz, the barrel material preferably is IC-36FS (|α_{G}−α_{M}|=0.1×10⁻⁶). When the lens material is optical glass (S-BSL7), the barrel material preferably is Ti-6A1-4V (|α_{G}−α_{M}|=1.6×10⁻⁶), SUS410 (|α_{G} α_{M}|=3.2×10⁻⁶), or the like.

The kinds of optical glass are not limited to the four listed in Table 1. There are about 200 kinds of optical glass, and the linear expansion coefficients of them are all distributed in a range of 14.5×10⁻⁶ to 5.4×10⁻⁶. Therefore, even in the case of a compound lens in which multiple kinds of optical glasses are combined, when the barrel material is SUS410, for example, |α_{G}−α_{M}| is 4.1 to 5.4×10⁻⁶ and thus Inequality (14) is satisfied. This is the same with other glass manufacturers. Also, when the barrel material is Ti-6A1-4V, |α_{G}−α_{M}| is 3.4 to 5.7×10⁻⁶, which satisfies Inequality (14). Combinations of the lens materials and the barrel materials are not limited to those described here, and combinations of various optical materials (glass, crystal, semiconductor, etc.) and barrel materials that satisfy Inequality (14) may be conceived.

Note that aluminum alloy, which is often used as the barrel material of a cheap compound lens, is not preferred from the viewpoint of thermal property considered here because the difference in the linear expansion coefficient between aluminum alloy and each of various optical materials does not satisfy Inequality (14).

The lens assembly 40 of the present embodiment can achieve the object of inputting an image from outside the barrel 42 or a position as close to the front end of the barrel 42 as possible, with a minimum number of components and without compromising the thickness of the component parts of the optical system.

Further, in the lens assembly 40 configured by the lens mount devices 10 described above, by balancing the aberration occurring due to an interval error caused by linear expansion of the barrel 42 and the aberration occurring due to refractive index change and dimensional change of the lens 12, spherical aberration due to temperature change can be suppressed (coaxial thermal aberration can be suppression).

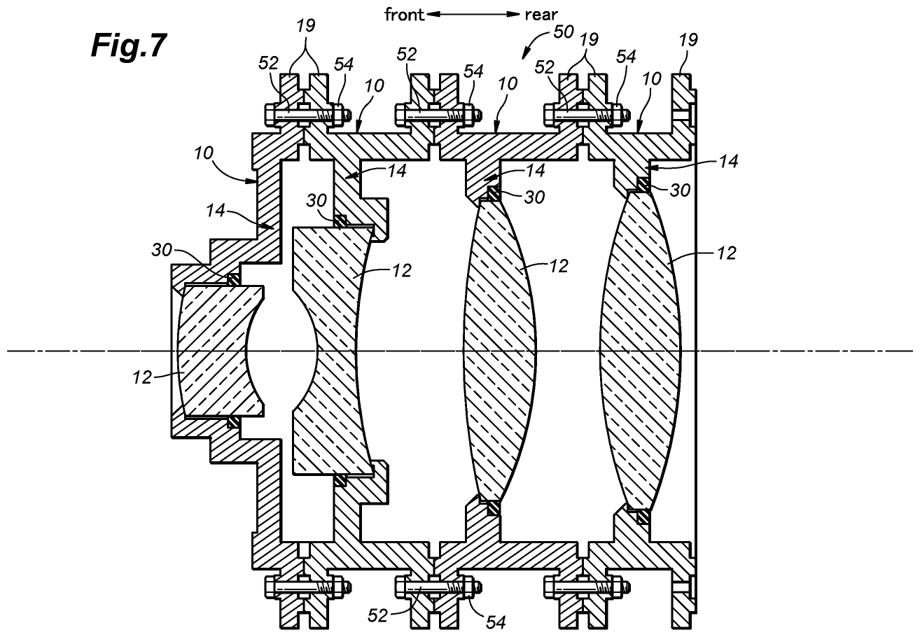

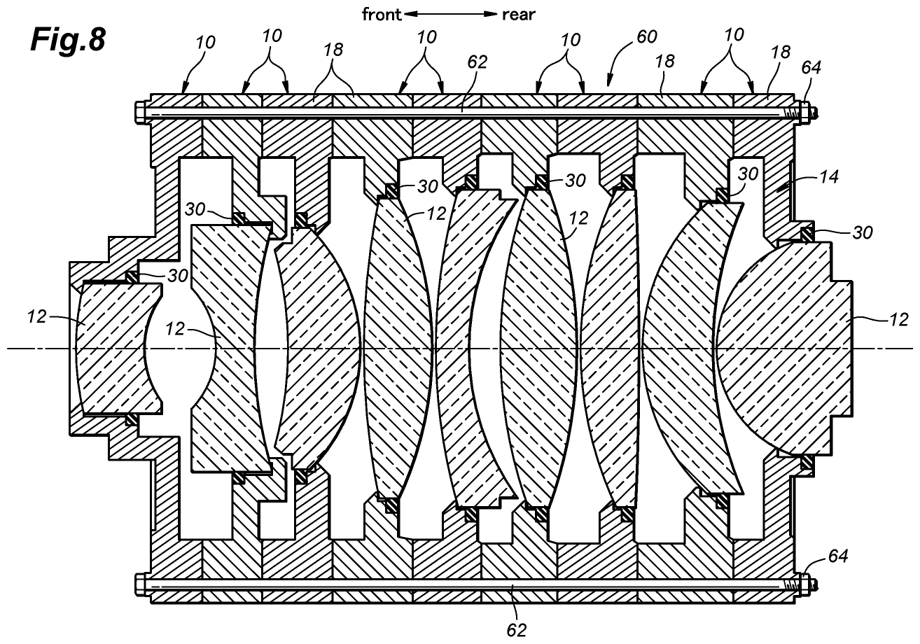

Other than the lens assembly 40 which uses the above-described barrel 42, the lens assembly according to the present invention may be embodied as lens assemblies 50, 60 as shown in FIGS. 7 and 8, respectively, in which the lens mount members 14 of the lens mount devices 10 that are adjacent to each other in the optical axis direction are coupled to each other by fasteners.

In the lens assembly 50 shown in FIG. 7, each lens mount member 14 is formed with two flange parts 19 that extend radially outward from the respective axial ends. As fasteners, bolts 52 penetrating through the flange parts 19 of the lens mount devices 10 that are adjacent to each other in the optical axis direction and nuts 54 threadedly engaged with the respective bolts 52 are provided, whereby the lens mount members 14 adjacent to each other in the optical axis direction are coupled to each other by the bolts 52 and the nuts 54.

The lens mount members 14 included in the lens assembly 50 may be made of materials having the same linear expansion coefficient. Also, the lenses 12 of the lens assembly 50 may be made of materials having the same linear expansion coefficient or mutually approximate linear expansion coefficients. The all lenses 12 of the lens assembly 50 may be made of CaF₂ or quartz, and in this case, the linear expansion coefficients of the lenses 12 are the same as each other.

Similarly to the above-described embodiment, when the materials of the lenses 12 of the multiple lens mount devices 10 in the lens assembly 50 are the same as each other, the lens mount members 14 corresponding to the respective lenses 12 can be made of materials having the same linear thermal expansion coefficient which is the same as or approximate to the linear thermal expansion coefficient of the lenses 12.

In this embodiment also, even under large temperature change, application of thermal stress to a specific lens mount device 10 or reduction of axial force can be avoided.

In the lens assembly 60 shown in FIG. 8, the lens mount devices 10 that are adjacent to each other in the optical axis direction are all coupled to each other by bolts 62 each penetrating through the lens mount members 14 of the all lens mount devices 10 and nuts 64 threadedly engaged with the respective bolts 62.

The lens mount members 14 included in the lens assembly 60 may be made of materials having the same linear expansion coefficient. Also, the lenses 12 of the lens assembly 40 may be made of materials having the same linear expansion coefficient or mutually approximate linear expansion coefficients. The all lenses 12 of the lens assembly 60 may be made of CaF₂ or quartz, and in this case, the linear expansion coefficients of the lenses 12 are the same as each other.

Similarly to the above-described embodiment, when the materials of the lenses 12 of the multiple lens mount devices 10 in the lens assembly 60 are the same as each other, the lens mount members 14 corresponding to the respective lenses 12 can be made of materials having the same linear thermal expansion coefficient which is the same as or approximate to the linear thermal expansion coefficient of the lenses 12.

In this embodiment also, even under large temperature change, application of thermal stress to a specific lens mount device 10 or reduction of axial force can be avoided.

In these embodiments, it is preferred that the bolts 52, 62 and the nuts 54, 54 for fastening the lens mount members 14 to each other are made of the material same as that of the lens mount members 14 from the viewpoint of thermal stress.

Note that these lens assemblies 40, 50, and 60 are typically suitable for use as an ultraviolet objective lens but may be also used as an ordinary microscope objective lens or a camera lens for visible wavelength width.

Concrete embodiments of the present invention have been described in the foregoing, but the present invention is not limited to the above embodiments and may be modified or altered in various ways. For example, as the shoulder portions 16G of the second and third lens mount devices 10 of the lens assembly 40 shown in FIG. 6, each shoulder portion 16G may be configured to contact a part of the exit surface (rear surface) of the corresponding lens 12 in the vicinity of the outer edge thereof to position the lens 12 relative to the lens mount member 14 in the axial direction. Instead of being formed by pouring liquid material into the first space 20 and curing it in the first space 20, the elastomer member 30 may be a pre-molded member fitted into the first space 20. The circular annular part 16 may be elliptical annular, rectangular annular or the like. The concrete structure, arrangement, number, material, etc. of each member or part described in the above embodiments may be appropriately changed without departing from the spirit of the present invention.

Other than mentioned above, a structure in which a barrel material having a linear expansion coefficient approximate to the linear expansion coefficient of the lens 12 is selected and the lens is fixed to the barrel via the elastomer member 30 is considered to have similar effects. Specifically, such combinations of the lens material and the barrel material may include a combination of CaF₂ and austenitic stainless steel, a combination of CaF₂ and brass, a combination of synthetic quartz and super invar, and a combination of optical glass and martensitic stainless steel or titanium alloy, and so on. Other than silicone rubber, the elastomer member 30 may be made of any elastomer material having elastomer properties similar to silicone rubber.

By making the lens and the lens mount member of materials having similar linear expansion coefficients and fixing them with an elastomer layer having a sufficient thickness, the linear expansion coefficient difference slightly remaining between the lens and the lens mount member can be absorbed, and thus, the present invention is applicable to fix the lens which is highly sensitive to decentration.

1. A lens mount device, comprising:
a lens; and
a lens mount member for holding the lens,
wherein the lens mount member has an annular part surrounding the lens,
the annular part comprises a first annular part having a first inner peripheral surface such that a first space having a first radial dimension is defined between the first inner peripheral surface and an outer peripheral surface of the lens and a second annular part having a second inner peripheral surface such that a second space having a second radial dimension smaller than the first radial dimension is defined between the second inner peripheral surface and the outer peripheral surface of the lens, the first annular part and the second annular part being adjacent to each other in an axial direction of the lens,
an elastomer member is placed in the first space without radial gaps, and
the second space is an air gap.

2. The lens mount device according to claim 1, wherein the lens mount member comprises a third annular part provided adjacent to the second annular part to define a shoulder portion contacting an incident surface or an exit surface of the lens.

3. The lens mount device according to claim 1, wherein the elastomer member extends continuously over an entire circumference of the first space.

4. The lens mount device according to claim 1, wherein the elastomer member is provided in at least three positions of the first space at intervals in a circumferential direction.

5. The lens mount device according to claim 1, wherein a material of the elastomer member is silicone rubber.

6. The lens mount device according to claim 5, wherein the elastomer member has a radial width greater than or equal to 2% of an outer diameter of the lens.

7. The lens mount device according to claim 1, wherein a material of the lens is CaF₂, and
a material of the lens mount member is austenitic stainless steel or brass.

8. The lens mount device according to claim 1, wherein a material of the lens is synthetic quartz, and
a material of the lens mount member is invar steel or super invar steel.

9. The lens mount device according to claim 1, wherein a material of the lens is optical glass, and
a material of the lens mount member is martensitic stainless steel, ferritic stainless steel, or titanium alloy.

10. A lens assembly, comprising:
multiple lens mount devices each consisting of the lens mount device according to claim 1; and
a barrel accommodating the multiple lens mount devices along an optical axis direction,
wherein materials of the lens mount members of the multiple lens mount devices are same as each other, and
a material of the barrel and the material of the lens mount members are same as each other.

11. The lens assembly according to claim 10, wherein materials of the lenses of the multiple lens mount devices are same as each other.

12. A lens assembly, comprising multiple lens mount devices arranged along an optical axis direction, each of the multiple lens mount devices consisting of the lens mount device according to claim 1,
wherein materials of the lens mount members of the multiple lens mount devices are same as each other, and
the lens mount members of the lens mount devices that are adjacent to each other in the optical axis direction are coupled to each other by fasteners.

13. The lens assembly according to claim 12, wherein materials of the lenses of the multiple lens mount devices are same as each other.
